(19) United States
(12) Patent Application Publication
(10) Pub. No.: US 2024/0397549 A1
(43) Pub. Date: Nov. 28, 2024

(54) CROSS-BSS TRANSMISSION OPPORTUNITY SHARING

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei (TW)

(21) Appl. No.: 18/660,143

(22) Filed: May 9, 2024

Related U.S. Application Data
(60) Provisional application No. 63/468,936, filed on May 25, 2023.

(51) Int. Cl. H04W 74/0808; H04W 84/12

(52) U.S. Cl. CPC H04W 74/0808; H04W 84/12

(57) ABSTRACT

A first station (STA) in a wireless network, the first STA comprising a memory and a processor coupled to the memory, the processor configured to: obtain a transmission opportunity (TXOP) for transmission of a frame through a plurality of subchannels on a link, allocate a portion of the TXOP to a second STA, wherein the portion of the TXOP specifies one or more subchannels of the plurality of subchannels, and transmit a notification to the second STA indicating allocation of the portion of the TXOP to the second STA.

### CROSS-REFERENCE TO RELATED APPLICATIONS

This application claims the benefit of priority from U.S. Provisional Application No. 63/468,936, entitled “Procedures for Cross-BSS TXOP Sharing” filed May 25, 2023, which is incorporated herein by reference in its entirety.

### TECHNICAL FIELD

This disclosure relates generally to a wireless communication system, and more particularly to, for example, but not limited to, transmission opportunity (TXOP) sharing in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network. The first STA comprises a memory and a processor coupled to the memory. The processor is configured to obtain a transmission opportunity (TXOP) for transmission of a frame through a plurality of subchannels on a link. The processor is configured to allocate a portion of the TXOP to a second STA, wherein the portion of the TXOP specifies one or more subchannels of the plurality of subchannels. The processor is configured to transmit a notification to the second STA indicating the allocation of the portion of the TXOP to the second STA.’

In some embodiments, the processor is further configured to receive an allocation of the TXOP from an access point (AP).

In some embodiments, the notification is a trigger frame.

In some embodiments, the trigger frame comprises a plurality of modes of operation that provide usage rules for the TXOP.

In some embodiments, the trigger frame indicates information about a duration of the portion of the TXOP that is allocated to the second STA.

In some embodiments, the second STA is an access point (AP) or a non-AP STA.

In some embodiments, a time duration of the portion of the TXOP is an entire time duration of the TXOP that is available for the allocation.

In some embodiments, a time duration of the portion of the TXOP is a portion of a time duration of the TXOP that is available for the allocation.

In some embodiments, the processor is further configured to allocate another portion of the TXOP to a third STA.

In some embodiments, the processor is configured to transmit or receive frames during a remaining portion of the TXOP on the link.

One aspect of the present disclosure provides an access point (AP) in a wireless network. The AP comprises a memory and a processor coupled to the memory. The processor is configured to obtain a transmission opportunity (TXOP) for transmission of a frame through a plurality of subchannels on a link. The processor is configured to allocate a portion of the TXOP to a station (STA), wherein the portion of the TXOP specifies one or more subchannels of the plurality of subchannels. The processor is configured to transmit a notification to the STA indicating allocation of the portion of the TXOP and to the STA.

In some embodiments, the processor is further configured to receive an allocation of the TXOP from another AP.

In some embodiments, the notification is a trigger frame.

In some embodiments, the trigger frame comprises a plurality of modes of operation that provide usage rules for the TXOP.

In some embodiments, the trigger frame indicates information about a duration of the portion of the TXOP that is allocated to the STA.

In some embodiments, the STA is an access point (AP) or a non-AP STA.

In some embodiments, a time duration of the portion of the TXOP is an entire time duration of the TXOP that is available for the allocation.

In some embodiments, a time duration of the portion of the TXOP is a portion of a time duration of the TXOP that is available for the allocation.

In some embodiments, the processor is further configured to allocate another portion of the TXOP to a different STA.

In some embodiments, the processor is configured to transmit or receive frames during a remaining portion of the TXOP on the link.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates Mode 1 operation of TXOP sharing in accordance with an embodiment.

FIG. 5 illustrates Mode 2 operation for both UL/DL and P2P communication in accordance with an embodiment.

FIG. 6 illustrates an AP sharing a TXOP according to TXOP sharing procedure in accordance with an embodiment.

FIG. 7 illustrates an example of a typical network with multiple BSS operating near each other.

FIG. 8 illustrates an example of an AP allocating a portion of a TXOP in accordance with an embodiment.

FIG. 9 illustrates an AP allocating an entire portion of a TXOP in accordance with an embodiment.

FIG. 10 illustrates an AP allocating only a portion a TXOP in accordance with an embodiment.

FIG. 11 illustrates an AP utilizing a TXOP for DL physical layer protocol data unit (PPDU) transmission in accordance with an embodiment.

FIG. 12 illustrates an AP using a TXOP for an entire bandwidth in accordance with an embodiment.

FIG. 13 illustrates an AP using a TXOP by using a set of subchannels in accordance with an embodiment.

FIG. 14 illustrates a flowchart of an example process for allocating a TXOP by one AP to another AP in accordance with an embodiment.

FIG. 15 illustrates a flowchart of an example process for utilizing a TXOP by an AP in accordance with an embodiment.

FIG. 16 illustrates a triggered TXOP sharing (TXS) trigger frame in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11bc. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

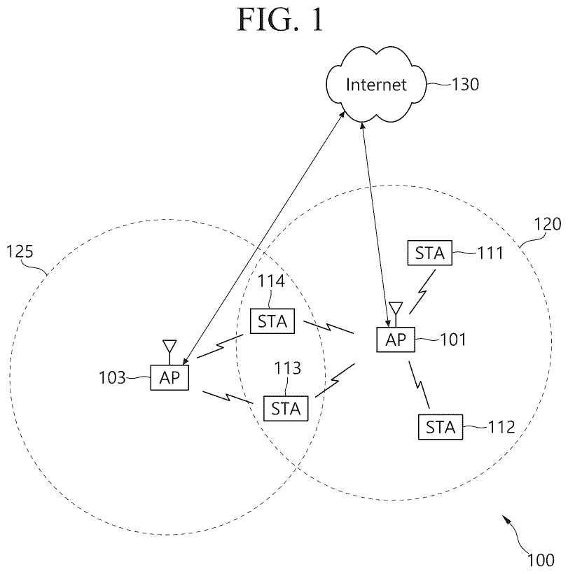

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, cach of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

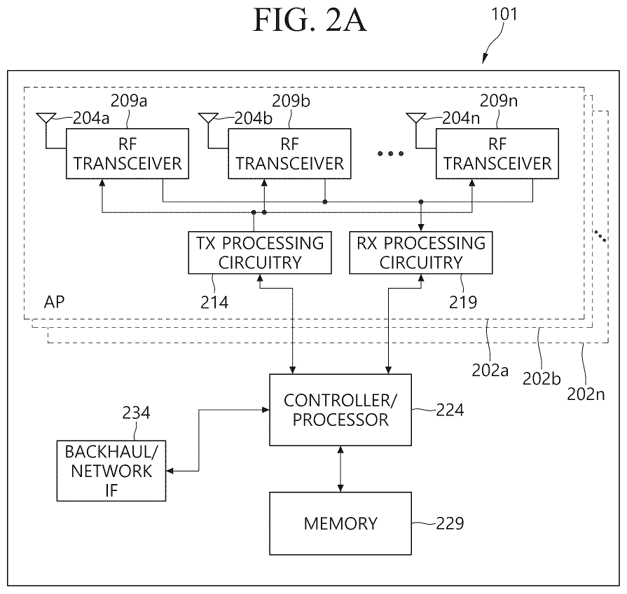

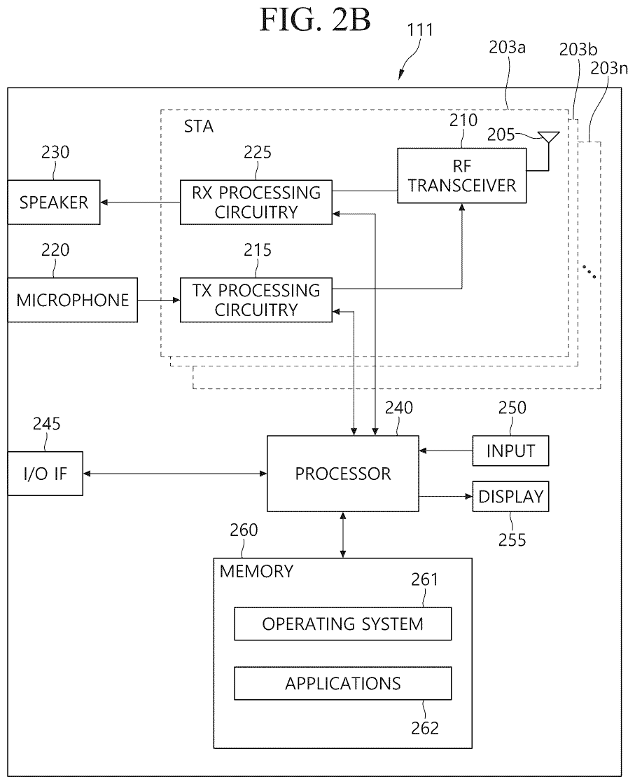

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but cach AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that cach STA 203a-203n has a separate antenna, but cach STA 203a-203n can share the antenna 205 without needing separate antennas. Each STA 203a-203n may represent a physical (PHY) layer and a lower media access control (MAC) layer.

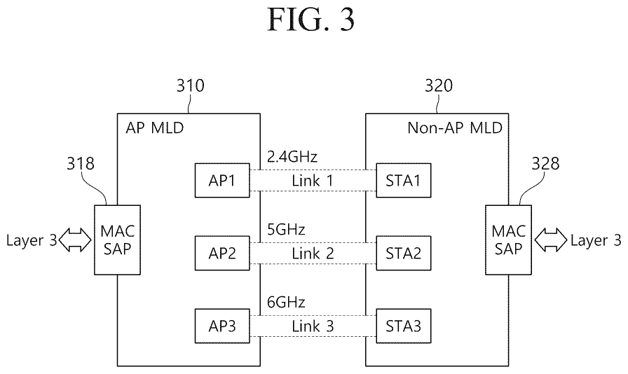

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Triggered TXOP Sharing (TXS) is a feature in IEEE 802.11be. Using the TXOP sharing procedure, an AP may help an STA to obtain the channel so that the STA can deliver its packets. TXOP sharing procedure may include the following five steps. In step 1, an AP may first obtain the channel, whereby the AP may obtain the TXOP for the wireless medium. In step 2, the AP may decide to allocate a portion of its obtained TXOP to a particular STA, for example STA1, in its BSS. In step 3, the AP may make some indication to STA1 that informs STA1 about the allocated TXOP. In step 4, the STA1 utilizes the allocated TXOP for its uplink or P2P communication. In step 5, the STA1 returns the TXOP to the AP after utilizing its allocated TXOP. The AP may indicate to an STA about the STA's allocated TXOP by using a multi-user request-to-send (MU-RTS) TXS frame, which is a trigger frame introduced in IEEE 802.11be. Currently, one MU-RTS TXS Trigger frame can allocate TXOP to a single STA only, and not more than one STAs.

There are two TXOP sharing modes, which include Mode 1 that is used only for uplink/downlink (UL/DL) communication and Mode 2 which may be used for both UL/DL and peer to peer (P2P) communication.

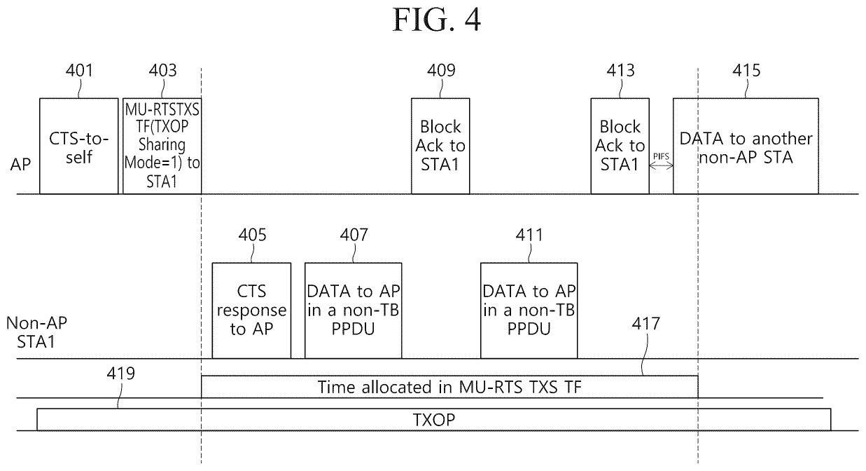

FIG. 4 illustrates Mode 1 operation of TXOP sharing in accordance with an embodiment. In the Mode 1 (UL/DL communication), the AP allocates the TXOP to a STA, illustrated as non-AP STA1, and indicates to the STA1 that the STA1 can use this TXOP 419 only to transmit uplink data packets.

In some embodiments, AP transmits a clear to send (CTS)-to-self 401. A CTS-to-self frame is a CTS frame in which the RA field is equal to the transmitter's MAC address. Then, AP transmits a MU-RTS TXS TF (TXOP Sharing Mode=1) 1403 to STA 1. AP allocates a portion of time, indicated as Time allocated in MU-RTS TXS TF 417, of the TXOP 419 to STA1. Accordingly, during the allocated portion of time 417, STA 1 exchanges frames with AP. For instance, STA1 transmits a CTS 405 response to AP. Subsequently, STA 1 transmits data in a non-Trigger Based Physical Layer Protocol Data Unit (non-TB PPDU) 407 to AP. The AP transmits a Block Ack 409 to STA1. STAI transmits another data in non-TB PPDU 411 to AP and the AP transmits a Block Ack 413 to STA1. Then, AP transmits data 415 to another non-AP STA.

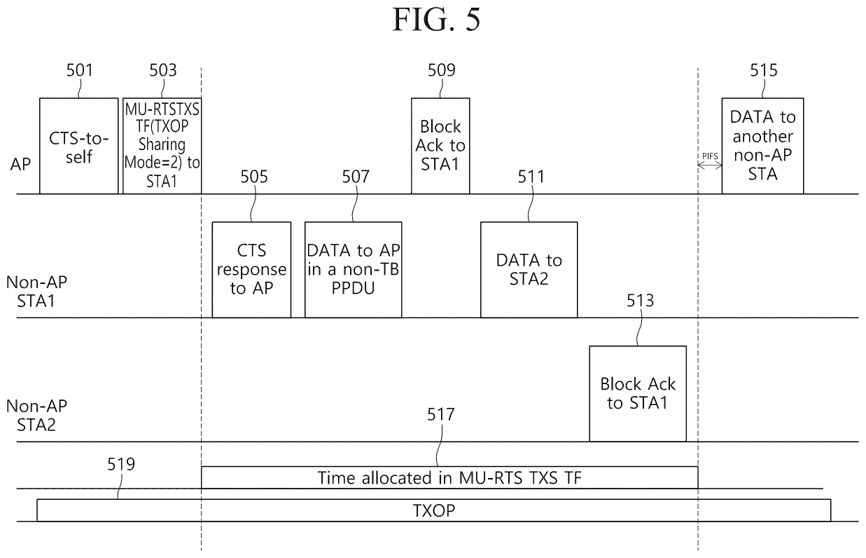

FIG. 5 illustrates Mode 2 operation for both UL/DL and P2P communication in accordance with an embodiment. In Mode 2, the AP allocates the TXOP to a STA and indicates to the STA that the STA can use this TXOP for both uplink communication and P2P communication. As illustrated in FIG. 5, the STA1 uses the TXOP for both uplink communication with the AP and P2P communication with STA2.

In some embodiments, AP transmits a CTS-to-self 501. In some embodiments, a CTS-to-self may allow an AP to obtain channel access protection, which may provide a lower overhead than a full request-to-send (RTS)/CTS exchange. Accordingly, AP transmits a MU-RTS TXS TF (TXOP Sharing Mode=2) 503 to STA 1. During TXOP 519, there is a portion of the TXOP time allocated for STA1, indicated as Time allocated in MU-RTS TXS TF 517. During the allocated time, STA1 transmits a CTS response 505 to the AP. STA1 transmits data in a non-TB PPDU 507 to the AP. The AP transmits a Block Ack 509 to the STA1. Subsequently, STA1 transmits data 511 to STA2. STA2 transmits a Block Ack 513 to STA 1. After the allocated portion in the MU-RTS TXS TF 517, AP transmits data 515 to another non-AP STA.

Accordingly, in the two TXOP sharing modes, only the access point (AP), after winning the contention, can share the won TXOP with a non-AP STA.

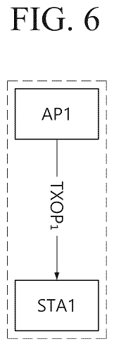

FIG. 6 illustrates an AP sharing an obtained TXOP with a non-AP STA in accordance with an embodiment. In FIG. 6, an AP obtained the TXOP and shares it with a non-AP STA. This scenario where TXOP sharing can be achieved based on the existing standards may be restrictive. Accordingly, many embodiments in this disclosure can improve TXOP sharing by extending the TXOP procedures. In particular, many embodiments provide procedures that include TXOP sharing to extend the TXOP procedures as described herein. In some embodiments, a first AP may share a TXOP with a second AP for the second AP's BSS operation.

Some embodiments provide multi-AP negotiation mechanisms for an AP to share a TXOP with another AP. In a typical network, there can be multiple BSSs operating near cach other.

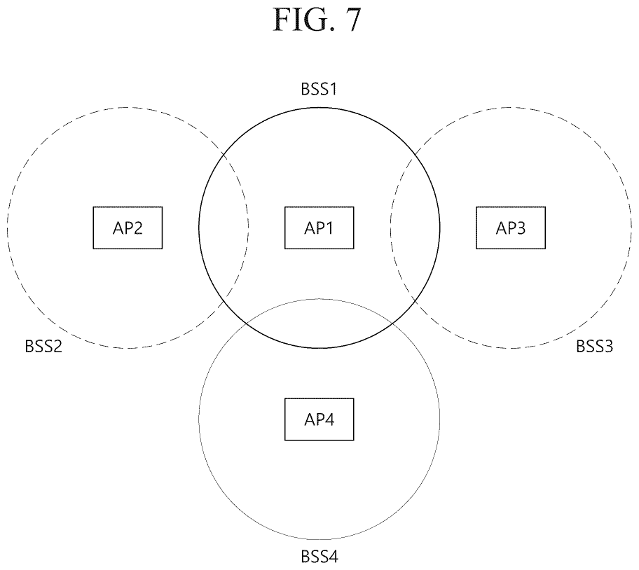

FIG. 7 illustrates an example of a network with multiple BSS in accordance with an embodiment. In FIG. 7, AP1 forms BSS1, AP2 forms BSS2, AP3 forms BSS3, and AP4 forms BSS4. The BSS coverages are overlapping and hence causing overlapping BSS (OBSS) interference. As illustrated, portions of the BSS1 coverage area overlap with BSS2, BSS3 and BSS4.

For example, due to OBSS interference, it is possible that a first STA in BSS1 can't get the opportunity to transmit its latency-sensitive traffic due to the channel being occupied by a second STA in a neighboring BSS (BSS1, BSS3, or BSS4). This may disrupt the first STA's latency-sensitive application.

In some embodiments, a first AP, upon obtaining a TXOP, may allocate a portion of the obtained TXOP to a second AP for transmission in the second AP's BSS.

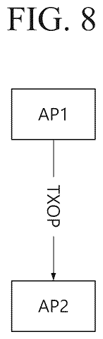

FIG. 8 illustrates an example of TXOP sharing in accordance with an embodiment. As illustrated in FIG. 8, AP1 may obtain a TXOP and AP1 may allocate a portion of the TXOP to AP2 for transmission in the AP2's BSS.

In some embodiments, a first AP can allocate the entire TXOP it obtained to a second AP.

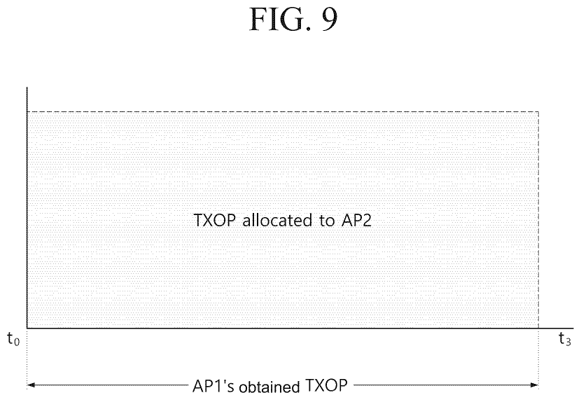

FIG. 9 illustrates an example of an AP allocating an entire portion of a TXOP to another AP in accordance with an embodiment. In FIG. 9, AP1 obtains a TXOP and allocates an entire TXOP to AP2. Note that the “entire” TXOP allocated to AP2 may not include the required time used by AP1 within the TXOP in order to indicate to AP2 about the TXOP allocation. As illustrated, AP1 allocates the TXOP to AP2 for an entire duration, indicated as from t₀ to t₃.

In some embodiments, an AP can allocate a portion of an obtained TXOP to a different AP

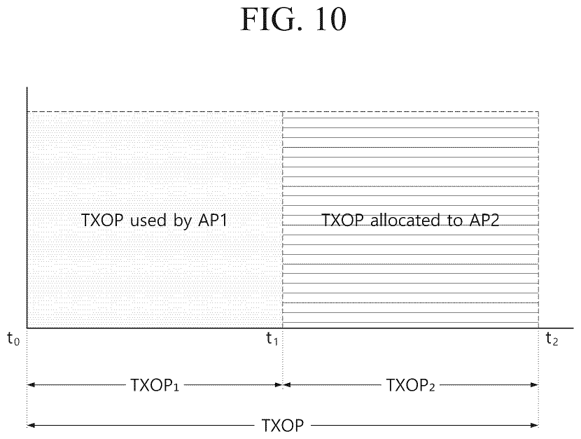

FIG. 10 illustrates allocating a portion of a TXOP in accordance with an embodiment. In FIG. 10, AP1 obtains a TXOP that has a duration from t₀ to t₂. AP1 uses a portion of the TXOP from time t₀ to t₁, indicated as TXOP1, to transmit data in the BSS of AP1. For example, AP1 may use TXOP1 for downlink transmission or for triggered uplink transmission. Subsequently after TXOP1, AP1 allocates a different portion of the TXOP, indicated as TXOP2, to AP2, where TXOP2 has a duration from t₁ to t₂.

In some embodiments, when an AP allocates a portion of a TXOP to another AP, the other AP can use the portion of the TXOP for downlink (DL) transmission or for transmission to other STAs.

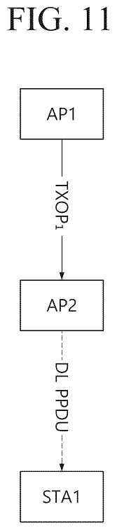

FIG. 11 illustrates an AP utilizing a TXOP for transmission of DL physical layer protocol data units (PPDUs) in accordance with an embodiment. In particular, AP1 allocates a TXOP, indicated as TXOP1, to AP2. AP2 then uses the allocated TXOP1 for DL PPDU transmission to an STA, indicated as STA1.

In some embodiments, when a first AP is allocated a TXOP from a second AP, the first AP can allocate a portion of the TXOP to a third AP, to another STA that is associated with the first AP, and/or to another STA that is not associated with the first AP.

In some embodiments, when a first AP allocates a portion of its TXOP to a second AP, the first AP can indicate the start time, the end time, and duration of the TXOP that is allocated to the second AP.

In some embodiments, when a first AP allocates a portion of its TXOP to a second AP, the first AP can indicate the channel(s) the second AP can use to utilize the TXOP in the second AP's BSS.

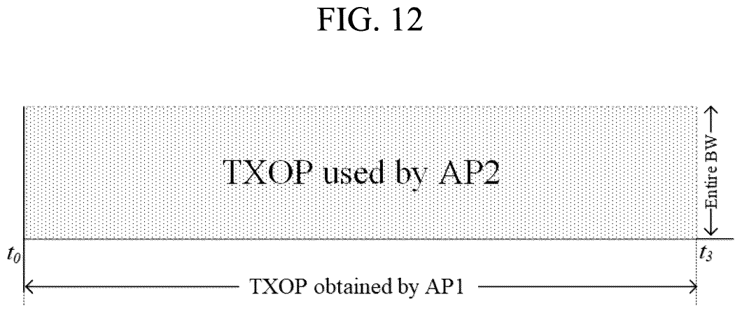

FIG. 12 illustrates an AP using a TXOP received from another AP for an entire bandwidth. In FIG. 12, AP1 wins the TXOP from time t₀ to time t₃. API allocates the TXOP to AP2 and indicates that AP2 can use the TXOP for frame transmission by any channel.

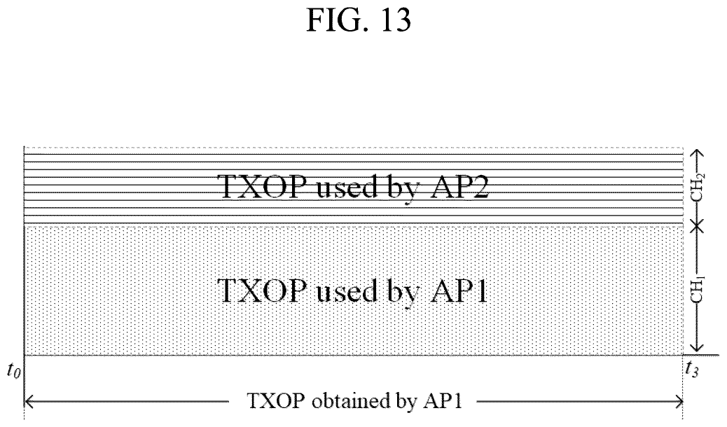

FIG. 13 illustrates an AP using a set of channels for a TXOP in accordance with an embodiment. In FIG. 13, AP1 obtains a TXOP from time t₀ to time t₃. AP1 uses a first channel, CH1, while transmitting during the TXOP. AP1 concurrently during the time t₀ to time t₃ also allocates the TXOP to AP2 and indicates that AP2 can use the TXOP by only using a second channel CH2. Accordingly, AP2 uses the TXOP by restricting its transmission only within channel CH2.

In some embodiments, when a first AP allocates a portion of its TXOP to a second AP, the first AP can indicate different modes of operation that may be allowed by using the allocated TXOP. Several of the different modes of operation that may be allowed by an AP are described below.

Mode-1: In this mode of operation, the second AP may be allowed to further allocate its received TXOP to another STA.

Mode-2: In this mode of operation, the second AP may be allowed to utilize the allocated TXOP for downlink transmission.

Mode-3: In this mode of operation, the second AP may be allowed to utilize the received TXOP for triggering uplink transmission from another STA in the second AP's BSS.

Mode-4: In this mode of operation, the second AP may be allowed to utilize the received TXOP for triggering another STA that is associated with the second AP for P2P transmission with another STA.

Mode-5: In this mode of operation, the second AP may be allowed to utilize the received TXOP for triggering another STA that is not associated with the second AP. Such triggering may trigger the STA for using the TXOP for the STA's P2P communication.

Mode-6: In this mode of operation, the second AP may be allowed to use the TXOP by using the channels that are indicated by the trigger frame.

Mode-7: In this mode of operation, the second AP may be allowed to use the TXOP by using any channel that may or may not be within the recommended set of channels as indicated in the trigger frame.

Mode-8: In this mode of operation, the second AP may be allowed to use the TXOP for transmitting the PPDUs that correspond to a set of TIDs that are indicated in the trigger frame.

Mode-9: In this mode of operation, the second AP may be allowed to use the TXOP for transmitting the PPDUs that may not correspond to a set of TIDs that are indicated in the trigger frame.

Mode-10: In this mode of operation, the second AP may be allowed to use the TXOP for transmission of latency-sensitive traffic in the second AP's BSS.

Mode-11: In this mode of operation, the second AP may be allowed to use the TXOP for both latency-sensitive and latency-tolerant traffic.

Mode-12: In this mode of operation, the second AP may be allowed to use the TXOP for transmission during an R-TWT SP (or any TWT SP).

Mode-13: In this mode of operation, the second AP may be allowed to use the TXOP for transmission with a power that is below a certain threshold. The threshold may be indicated in the trigger frame.

Mode-14: In this mode of operation, the second AP may be allowed to use the TXOP for transmission with a certain set of Enhanced Distributed Channel Access (EDCA) parameters.

Mode-15: In this mode of operation, the second AP may be allowed to use the TXOP for transmission using a certain set of operating classes as indicated by the first AP.

Mode-16: In this mode of operation, the second AP may be allowed to use the TXOP for transmission using an operating class that may or may not be with a set of operating classes that is indicated by the first AP.

In some embodiments, a first AP that receives a TXOP from a second AP may use the TXOP by following rules that are governed by one or more subsets of the above-mentioned modes of operation. In some embodiments, the first AP may use the TXOP by following rules that are governed by one or more combinations of the above-mentioned modes of operation.

In some embodiments, when a first AP allocates a portion of its TXOP, TXOP1, to a second AP, the first AP can send an indication to the second AP informing the second AP about the TXOP allocation. Such an indication can be made by sending a frame to the second AP. Such a frame can be a trigger frame or other types of frame. An example of a trigger frame for this purpose is a multi-AP triggered transmission opportunity (MAP TXS) Trigger frame. Through such a frame the first AP may also indicate the mode of usage of the allocated TXOP by the second AP or may also indicate a set of rules that the second AP may need to follow in order to utilize the TXOP allocated to the second AP by the first AP. In some embodiments, a set of information contents carried by the MAP TXS Trigger frame can include information elements described in Table 1.

TABLE 1

| Order | Information | Notes |
|---|---|---|
| 1 | TXOP start time | The time indicating the start of the TXOP |
| | | that is being allocated to the recipient of the |
| | | frame |
| 2 | TXOP end time | The time indicating the end of the TXOP that |
| | | is being allocated to the recipient of the |
| | | frame |
| 3 | TXOP duration | A time duration indicating the duration of the |
| | | TXOP that is allocated to the recipient of the |
| | | TXOP. |
| 4 | AID set | A set of association IDs (AIDs) indicating |
| | | the STAs that can utilize the TXOP |
| 5 | TIDS | Indicates a set of traffic IDs (TIDs). The |
| | | traffic corresponding to this set of TIDs can |
| | | be transmitted by utilizing the allocated |
| | | TXOP |
| 6 | Power Constraint | Indicates the power constraints for utilizing |
| | | the TXOP that is being allocated to recipient |
| | | of the frame. The Power Constraint element |
| | | is present if |
| | | dot11SpectrumManagementRequired is true |
| | | and is optionally present if |
| | | dot11RadioMeasurementActivated is true. |
| 7 | EDCA Parameter | Indicates the Distributed Channel Access |
| | Set | (EDCA) parameters that may need to be used |
| | | for utilizing the TXOP that is being allocated |
| | | to recipient of the frame. The EDCA |
| | | Parameter Set element is present if |
| | | dot11QosOptionImplemented is true and |
| | | dot11MeshActivated is false. |
| 8 | Supported | Indicates the set of operating classes that |
| | Operating Classes | may need to be used for utilizing the TXOP |
| | | that is being allocated to recipient of the |
| | | frame. The Supported Operating Classes |
| | | element is present if |
| | | dot11ExtendedChannelSwitchActivated or |
| | | dot11OperatingClassesRequired is true. |
| | | The Supported Operating Classes element is |
| | | optionally present if |
| | | dot11TVHTOptionImplemented is true. |
| 9 | Supported | Indicates the set of operating classes that |
| | Operating Classes | may need to be used for utilizing the TXOP |
| | | that is being allocated to recipient of the |
| | | frame. The Supported Operating Classes |
| | | element is present if |
| | | dot11ExtendedChannelSwitchActivated or |
| | | dot11OperatingClassesRequired is true. |
| | | The Supported Operating Classes element is |
| | | optionally present if |
| | | dot11TVHTOptionImplemented is true. |
| 10 | Operating Classes | Indicates the set of channels and operating |
| | and Channel field | classes that may need to be used for utilizing |
| | | the TXOP that is being allocated to recipient |
| | | of the frame. The Supported Operating |
| | | Classes element is present if |
| | | dot11ExtendedChannelSwitchActivated or |
| | | dot11OperatingClassesRequired is true. |
| | | The Supported Operating Classes element is |
| | | optionally present if |
| | | dot11TVHTOptionImplemented is true. |
| 11 | TWT | Indicates the set of service periods during |
| | | which the TXOP can be utilized. |
| 12 | Spatial Reuse | Indicates the spatial reuse parameters that |
| | Parameter Set | may need to be used for transmitting during |
| | | using the allocated TXOP. The Spatial Reuse |
| | | Parameter Set element is optionally present if |
| | | dot11HEOptionImplemented is true; |
| | | otherwise, it is not present. |
| 13 | Multi-Link | Indicates the multi-link link information |
| | | corresponding to the usage of the allocated |
| | | TXOP. |

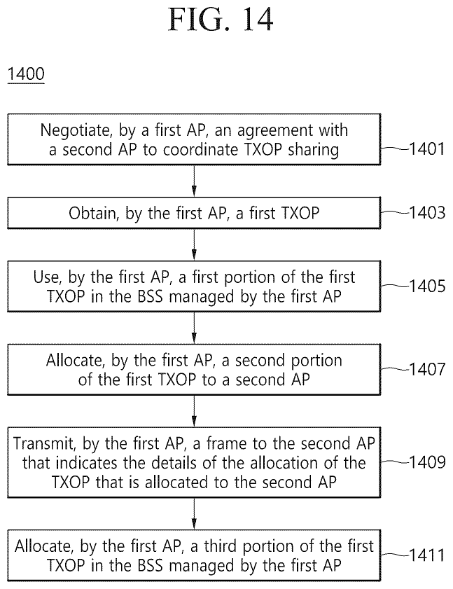

FIG. 14 illustrates an example process for allocating an obtained TXOP by one AP to another AP in accordance with an embodiment. For explanatory and illustration purposes, the example process 1400 may be performed by the AP depicted in FIGS. 1 and 3. Although one or more operations are described or shown in particular sequential order, in other embodiments the operations may be rearranged in a different order, which may include performance of multiple operations in at least partially overlapping time periods.

In operation 1401 of the process 1400, the first AP negotiates an agreement with a second AP to coordinate TXOP sharing. In some embodiments, the negotiation can include determining a set parameters related to the TXOP sharing, including further allocation of the TXOP to other STAs, time duration of the TXOP, particular subchannels that may be used by STAS, among various other conditions. In some embodiments, multiple APs can coordinate and share among themselves their time/frequency resources within a TXOP.

In operation 1403, the first AP obtains a first TXOP. For example, if there are two or more APs within range using the same channel, with no coordination each of them would contend for the channel and the AP that wins the contention would then reserve the channel using the TXOP concept. The other APs would have to defer from channel access and wait for the TXOP to end.

In operation 1405, the first AP uses a first portion of the first TXOP in the BSS managed by the first AP.

In operation 1407, the first AP allocates a second portion of the first TXOP to a second AP

In operation 1409, the first AP transmits a frame to the second AP that indicates the details of the allocation of the TXOP that is allocated to the second AP.

In operation 1411, the first AP allocates a third portion of the first TXOP in the BSS managed by the first AP.

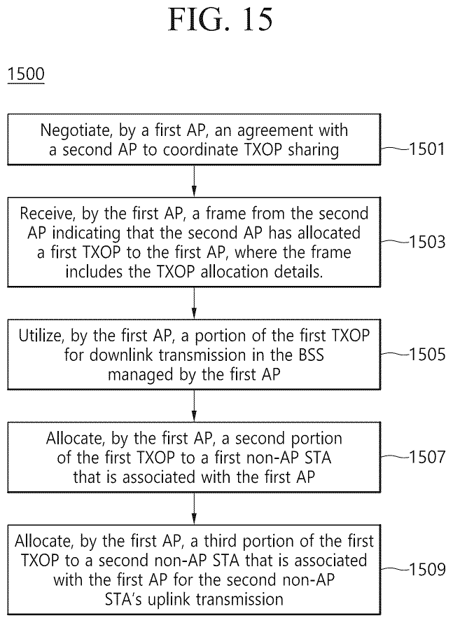

FIG. 15 illustrates a flowchart of an example process for utilizing a TXOP by an AP, where the TXOP is received from another AP in accordance with an embodiment. For explanatory and illustration purposes, the example process 1500 may be performed by the AP depicted in FIGS. 1 and 3. Although one or more operations are described or shown in particular sequential order, in other embodiments the operations may be rearranged in a different order, which may include performance of multiple operations in at least partially overlapping time periods.

In operation 1501 of the process 1500, the first AP may negotiate an agreement with a second AP to coordinate TXOP sharing. In operation 1503, the first AP receives a frame from the second AP indicating that the second AP has allocated a first TXOP to the first AP, where the frame includes the TXOP allocation details. In operation 1505, the first AP utilizes a portion of the first TXOP for downlink transmission in the BSS managed by the first AP. In operation 1507, the first AP allocates a second portion of the first TXOP to a first non-AP STA that is associated with the first AP. In operation 1509, the first AP allocates a third portion of the first TXOP to a second non-AP STA that is associated with the first AP for the second non-AP STA's uplink transmission.

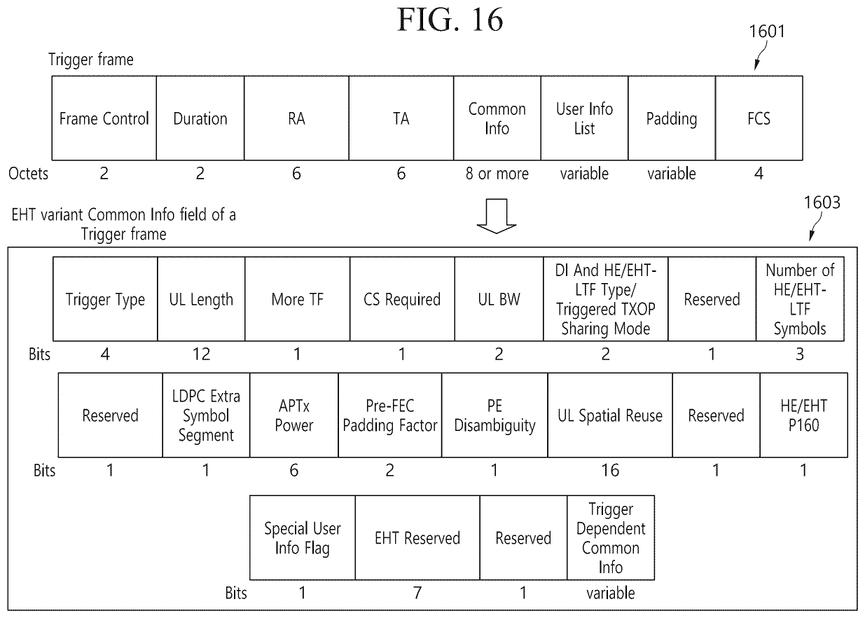

FIG. 16 illustrates an MU-RTS TXS frame in accordance with an embodiment. In particular, FIG. 16 illustrates an MU-RTS TXS trigger frame 1601 and an EHT variant Common Info field 1603 of the trigger frame. The MU-RTS TXS frame can include one or more fields, including, but not limited to, a frame control field, a duration field, a receiver address (RA) field, a transmitter address (TA) field, a Common Info field, a User Info List field, a Padding field, and a frame check sequence (FCS) field.

The Frame control field can include a value to indicate the type of frame. The Duration field may be set to the estimated time, in microseconds, required to transmit the pending frame(s). The Receiver Address (RA) field may include the address of the receiver of frame. The Transmitter Address (TA) field may include the address of the transmitter of the frame. The Common Info Field may indicate the MU-RTS TXS Mode and include one or more subfields, as described below. The User Info List may indicate a value of the bandwidth (BW) associated with the MU-RTS frame (and/or BW associated with the PPDU carrying the MU-RTS frame—for example, but not limited to, 320 MHz, 160+160 MHz, 240 MHz, 160+80 MHz). The Padding field may be used for additional padding to compensate for different lengths of different MU-RTS frames. The FCS field is a frame check sequence for error-detection.

The EHT variant Common Info field 1603 of the trigger frame 1601 may include a Trigger Type field, a UL length field, a More Trigger Frame (TF) field, a Carrier Sense (CS) required field, an Up Link Bandwidth (UL BW) field, A DI and HE/E HT-LTF Type/Triggered TXOP Sharing Mode field, a Reserved Field, a Number of HE/EHT-LTF Symbols field, a Reserved field, a Low-Density Parity Check (LDPC) Extra Symbol Segment field, a AP transmitter (TX) power field, a Pre-FEC Padding Factor field, a PE Disambiguity field, a UL Spatial Resue field, a Reserved field, an HE/EHT P160 filed, a Special User Info Flag field, a EHT Reserved field, a Reserved field, and a Trigger Dependent Common Info field.

The trigger type field may indicate a MU-RTS trigger frame. The UL Length field may signal a length of the expected response frame. The More TF field may indicate whether or not a subsequent trigger frame is scheduled for transmission. The CS Required field is set to 1 to indicate that the STAs identified in the User Info fields are required to use Energy Detect (ED) to sense the medium and to consider the medium state and the Network Allocation Vector (NAV) in determining whether or not to respond. The UL BW field (Up Link Bandwidth) indicates the bandwidth of the transmission. The GI and HE/EHT LTF Type/Triggered TXOP Sharing Mode field indicates the guard interval and long training field (GI and HE/EHT-LTF) type of the HE or EHT TB PPDU response, and the field may switch meaning between GI and HE/EHT-LTF type and triggered TXOP sharing mode fields based on the trigger type.

The Reserved field is reserved. The Number of HE/EHT LTF Symbols field indicates the number of HE-LTF symbols present in the HE TB PPDU or EHT-LTF symbols present in the EHT TB PPDU, respectively. The Reserved field is reserved. The LDPC Extra Symbol Segment field indicates the status of the LDPC extra symbol segment. The AP TX Power field provides the Tx Power used to transmit the frame. The Pre-FEC Padding Factor field indicates the pre-FEC padding factor. The PE Disambiguity field indicates the PE disambiguity. The UL Spatial Reuse field carries the values to be included in the Spatial Reuse fields in the HE-SIG-A field of the solicited HE TB PPDUs. The Reserved field is reserved. The HE/EHT P160 field may indicate whether the solicited TB PPDU in the primary 160 MHz is an EHT TB PPDU or an HE TB PPDU. The Special User Info Flag field may indicate that a Special User Info field is included in the Trigger frame that contains the EHT variant Common Info field. The EHT Reserved field is reserved. The Reserved field is reserved. The Trigger Dependent Common Info field is optionally present based on the value of the Trigger Type field.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, the first STA comprising:
a memory; and
a processor coupled to the memory, the processor configured to:
obtain a transmission opportunity (TXOP) for transmission of a frame through a plurality of subchannels on a link;
allocate a portion of the TXOP to a second STA, wherein the portion of the TXOP specifies one or more subchannels of the plurality of subchannels; and
transmit a notification to the second STA indicating the allocation of the portion of the TXOP to the second STA.

2. The first STA of claim 1, wherein the processor is further configured to receive an allocation of the TXOP from an access point (AP).

3. The first STA of claim 1, wherein the notification is a trigger frame.

4. The first STA of claim 3, wherein the trigger frame comprises a plurality of modes of operation that provide usage rules for the TXOP.

5. The first STA of claim 3, wherein the trigger frame indicates information about a duration of the portion of the TXOP that is allocated to the second STA.

6. The first STA of claim 1, wherein the second STA is an access point (AP) or a non-AP STA.

7. The first STA of claim 1, wherein a time duration of the portion of the TXOP is an entire time duration of the TXOP that is available for the allocation.

8. The first STA of claim 1, wherein a time duration of the portion of the TXOP is a portion of a time duration of the TXOP that is available for the allocation.

9. The first STA of claim 1, wherein the processor is further configured to allocate another portion of the TXOP to a third STA.

10. The first STA of claim 1, wherein the processor is configured to transmit or receive frames during a remaining portion of the TXOP on the link.

11. An access point (AP) in a wireless network, the AP comprising:
a memory;
a processor coupled to the memory, the processor configured to:
obtain a transmission opportunity (TXOP) for transmission of a frame through a plurality of subchannels on a link;
allocate a portion of the TXOP to a station (STA), wherein the portion of the TXOP specifies one or more subchannels of the plurality of subchannels; and
transmit a notification to the STA indicating allocation of the portion of the TXOP and to the STA.

12. The AP of claim 11, wherein the processor is further configured to receive an allocation of the TXOP from another AP.

13. The AP of claim 11, wherein the notification is a trigger frame.

14. The AP of claim 13, wherein the trigger frame comprises a plurality of modes of operation that provide usage rules for the TXOP.

15. The AP of claim 13, wherein the trigger frame indicates information about a duration of the portion of the TXOP that is allocated to the STA.

16. The AP of claim 11, wherein the STA is an access point (AP) or a non-AP STA.

17. The AP of claim 11, wherein a time duration of the portion of the TXOP is an entire time duration of the TXOP that is available for the allocation.

18. The AP of claim 11, wherein a time duration of the portion of the TXOP is a portion of a time duration of the TXOP that is available for the allocation.

19. The AP of claim 11, wherein the processor is further configured to allocate another portion of the TXOP to a different STA.

20. The AP of claim 11, wherein the processor is configured to transmit or receive frames during a remaining portion of the TXOP on the link.
